(19) United States
(12) Patent Application Publication
(10) Pub. No.: US 2009/0055579 A1
(43) Pub. Date: Feb. 26, 2009

(54) Semiconductor memory device for simultaneously programming plurality of banks

(75) Inventors: June-hong Park, Seongnam-si (KR); Jae-yong Jeong, Yongin-si (KR); Chi-weon Yoon, Seoul (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/230,142

(22) Filed: Aug. 25, 2008

(30) Foreign Application Priority Data
Aug. 24, 2007 (KR) 10-2007-0085572

(51) Int. Cl. G06F 12/02

(52) U.S. Cl. 711/103; 711/E12.008

(57) ABSTRACT

Provided is a semiconductor memory device for simultaneously programming a plurality of banks. The semiconductor memory device includes: a memory cell array comprising a plurality of banks; a plurality of data buffers storing a plurality of pieces of program data to be programmed in the corresponding banks; and a plurality of scan latches configured to scan the plurality of program data transmitted from the corresponding data buffers, and configured to generate 1^{st} through n−1^{th} sub program data, n being a natural number greater than 2.

### PRIORITY STATEMENT

This application claims priority under 35 U.S.C. §119 to Korean Patent Application No. 10-2007-0085572, filed on Aug. 24, 2007, in the Korean Intellectual Property Office (KIPO), the entire contents of which are incorporated herein by reference.

### BACKGROUND

1. Field

Example embodiments relate to a flash memory device, and more particularly to, a NOR flash memory device for simultaneously programming a plurality of banks.

2. Description of the Related Art

Flash memory, which may use nonvolatile memory devices for electrically deleting or recording data, may demonstrate lower power consumption than magnetic disc memory based storage media and may have fast access time similar to hard disks.

Flash memory is classified into NOR type flash memory and NAND type flash memory according to a connection of cells and bit lines. NOR type flash memory may have one bit line and two or more cell transistors connected in parallel, store data using a channel hot electron method, and erase data using a Fowler-Nordheim (F-N) tunneling method. NAND type flash memory may have one bit line and two or more cell transistors connected in serial, store and erase data using the F-N tunneling method. Although NOR type flash memory may be less desirable for highly integrated circuits due to a large amount of current consumption, they may be desirable for high speed operation. Meanwhile, since NAND type flash memory may use less cell current than NOR type flash memory, they may be desirable for highly integrated circuits.

FIG. 1A is a circuit diagram of memory cells which may be included in a conventional NAND type flash memory. Referring to FIG. 1A, the conventional NAND type flash memory depicted in FIG. 1A includes a plurality of word lines WL11-WL14, a plurality of memory cells M11-M14 that form a string structure with selective transistors ST1 and ST2 and that are connected to a bit line BL and a ground voltage VSS in serial. Since the conventional NAND type flash memory may use a small amount of cell current, a NAND type nonvolatile semiconductor memory device program all memory cells connected to one word line during one program operation.

FIG. 1B is a circuit diagram of memory cells which may be included in a conventional NOR type flash memory. Referring to FIG. 1B, each of memory cells M21 through M26 are connected to bit lines BL1 and BL2 and a source line CSL in the NOR type nonvolatile semiconductor memory device depicted in FIG. 1B. Since the conventional NOR type flash memory may consume a large amount of current during a program operation, it may program a specific number of memory cells during one program operation.

FIG. 2A is a graph illustrating a cell threshold voltage versus storage data when a flash memory device has a single level memory cell. FIG. 2B is a graph illustrating a cell threshold voltage versus storage data when a flash memory device has a multi level memory cell.

Referring to FIG. 2A, one bit data is stored at two different threshold voltages that are programmed in the single level memory cell. For example, when a threshold voltage that is programmed in the single level memory cell is 1V-3V, data logic “1” may be stored in the single level memory cell. When a threshold voltage that is programmed in the single level memory cell is 5V-7V, data logic “0” may be stored in the single level memory cell.

Referring to FIG. 2B, two bit data is stored at four different threshold voltages that are programmed in the multi level memory cell. For example, when a threshold voltage that is programmed in the multi level memory cell is 1V-3V, data logic “11” may be stored in the multi level memory cell. When a threshold voltage that is programmed in the multi level memory cell is 3.8V-4.2V, data logic “10” may be stored in the multi level memory cell. When a threshold voltage that is programmed in the multi level memory cell is 4.8V-5.4V, data logic “01” may be stored in the multi level memory cell. When a threshold voltage that is programmed in the multi level memory cell is 6.5V-7.0V, data logic “00” may be stored in the multi level memory cell.

Data stored in a single or multi level memory cell may be identified according to a difference in a cell current during a data read operation. An operation and type of a flash memory described above is well known to one of ordinary skill in the art and thus their detailed description is not provided.

Hereinafter, a buffer program method of enhancing a program speed in a NOR type flash memory will now be described. The NOR type flash memory may include a plurality of banks. Each bank may share a data line for inputting and outputting a data line. Each bank may include sectors comprising a plurality of nonvolatile memory cells.

The NOR type flash memory may perform an erasure operation by sectors, and perform a program operation by a word or N words having consecutive addresses existing in one sector.

To perform the program operation, the NOR type flash memory may receive a program instruction, receive a program address and program data to be programmed, temporarily store the program address and the program data in a buffer, select a memory cell corresponding to the program address, and apply a program voltage corresponding to the program data to the selected memory cell.

An authentication operation of comparing program data programmed in a selected memory cell and program data stored in a buffer after an internally predetermined period of time of programming program data in a memory cell may be performed. If the program data programmed in the selected memory cell and program data stored in the buffer are identical to each other, the program operation may end. If not, the program operation and the authentication operation may be repeated.

However, although the NOR type flash memory device may use a buffer program method in order to enhance a program speed, when different banks use a buffer in order to program a plurality of banks, it may be impossible to program the plurality of banks.

### SUMMARY

Example embodiments provide a semiconductor memory device for enhancing a program speed in a NOR flash memory device including a plurality of banks.

According to example embodiments, there is provided a semiconductor memory device comprising: a memory cell array including a plurality of banks; and a plurality of data buffers configured to store a plurality of pieces of program data to be programmed in the corresponding banks.

Each of the plurality of data buffers may correspond to a bank from among the plurality of banks.

At least one of the plurality of data buffers may correspond to at least two banks.

The semiconductor memory device may further comprise: a data transmission line shared by the plurality of banks and the plurality of data buffers and transmitting the plurality of program data.

The semiconductor memory device may further comprise: a controller configured to time-share the data transmission line permission of the plurality of banks and the plurality of data buffers, and configured to control a transmission of the plurality of program data between the corresponding banks and data buffers.

The semiconductor memory device may simultaneously perform a program operation with regard to the plurality of banks in response to a first control signal.

The semiconductor memory device may simultaneously perform a verifying operation with regard to the plurality of banks in response to a second control signal.

The semiconductor memory device may further comprise: a plurality of scan latches scanning the plurality of program data transmitted from the corresponding data buffers and generating 1^{st} through n−1^{th} sub program data where n may be a natural number greater than 2.

The value n may be 2 when the semiconductor memory device is a single level cell (SLC) flash memory device, and n may be 4 when the semiconductor memory device is a multi level cell (MLC) flash memory device.

Each of the plurality of scan latches may be included in each of the plurality of data buffers.

The plurality of scan latches may be shared by some of the plurality of data buffers.

The semiconductor memory device may further comprise: a plurality of write driver latches storing k^{th} sub program data while the k^{th} sub program data is programmed, where k is a natural number such that 1≦k≦n−1.

Each of the plurality of write driver latches may be included in each of the plurality of banks.

The plurality of write driver latches may be shared by some of the plurality of banks.

Two or more memory banks may share a single write drive latch.

The plurality of write driver latches may be disposed between the plurality of banks and the data transmission line.

The plurality of write driver latches may be disposed between the data transmission line and the plurality of data buffers.

If k is not n−1, the plurality of scan latches may generate the k+1^{th} sub program data while the k^{th} sub program data is programmed.

The semiconductor memory device may further comprise: a plurality of level shifters applying bias voltages corresponding to the sub program data to bit lines connected to memory cells for programming the plurality of program data.

Each of the level shifters may be included in each bank.

The semiconductor memory device may be a NOR flash memory device.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1A is a circuit diagram of memory cells included in a conventional NAND type flash memory;

FIG. 1B is a circuit diagram of memory cells included in a conventional NOR type flash memory;

FIG. 2A is a graph illustrating a cell threshold voltage versus storage data when a flash memory device has a single level memory cell;

FIG. 2B is a graph illustrating a cell threshold voltage versus storage data when a flash memory device has a multi level memory cell;

FIG. 3 is a diagram of a semiconductor memory device according to example embodiments;

FIG. 4 is a block diagram of a semiconductor memory device according to example embodiments;

FIG. 5 is a block diagram of a semiconductor memory device according to example embodiments;

FIG. 6 is a block diagram of a semiconductor memory device according to example embodiments;

FIGS. 7A and 7B are diagrams for explaining sub program data;

FIG. 8 is a diagram for explaining an operation of the semiconductor memory device shown in FIGS. 4 through 6;

FIG. 9 is a flowchart illustrating a program method used by the semiconductor memory device shown in FIG. 3 according to example embodiments;

FIG. 10 is a diagram of a semiconductor memory device according to example embodiments; and

FIG. 11 is a block diagram of a semiconductor memory device according to example embodiments.

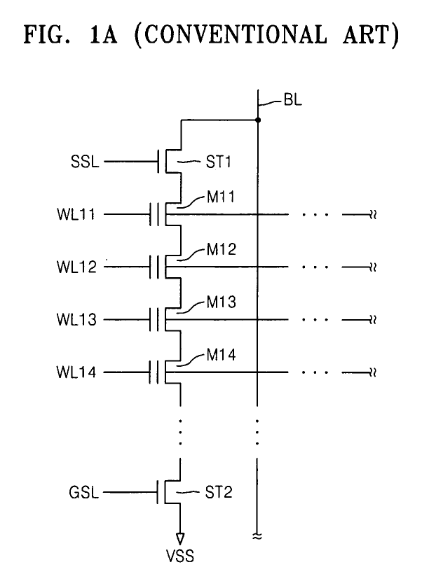

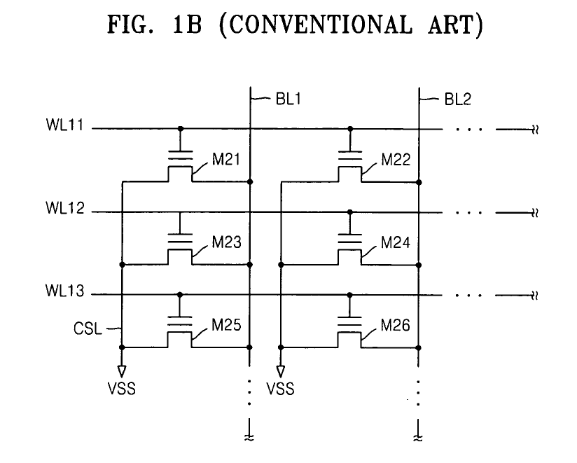

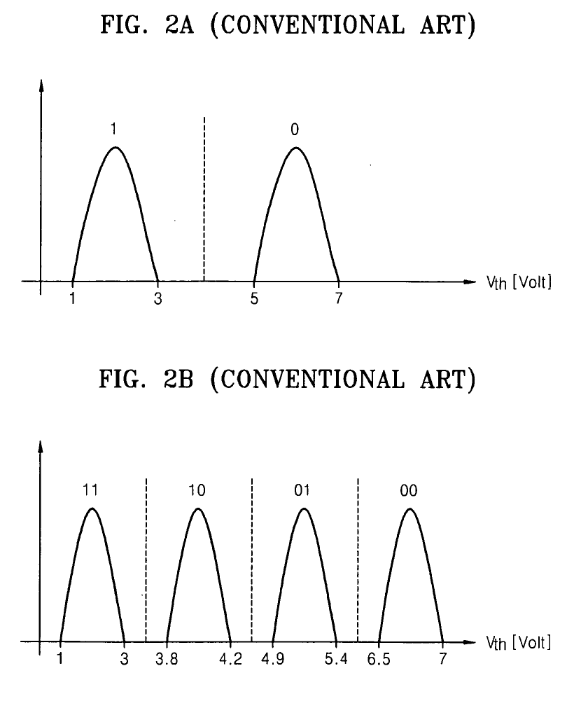

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

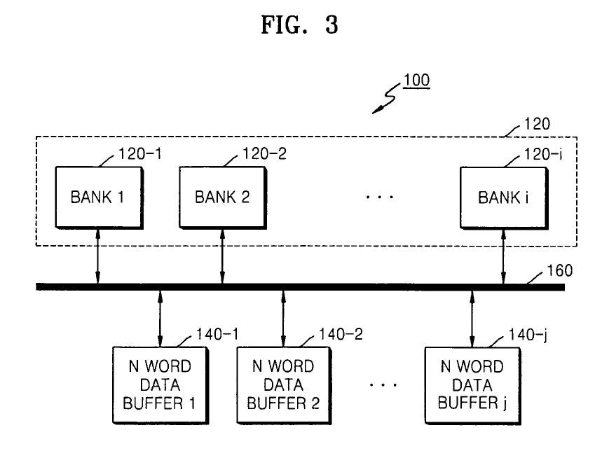

FIG. 3 is a diagram of a semiconductor memory device 100 according to example embodiments. Referring to FIG. 3, the semiconductor memory device 100 may comprise a memory cell array 120 and a plurality of data buffers 140-1 through 140-i. The semiconductor memory device 100 and other semiconductor memory devices shown in the following figures may be NOR flash memory devices.

The memory cell array 120 may comprise a plurality of banks 120-1 through 120-i. The plurality of data buffers 140-1 through 140-i may store program data to be programmed in the plurality of banks 120-1 through 120-i. The semiconductor memory device 100 may further comprise a data transmission line 160. The data transmission line 160 may be shared by the plurality of banks 120-1 through 120-i and the plurality of data buffers 140-1 through 140-i and may transmit the program data.

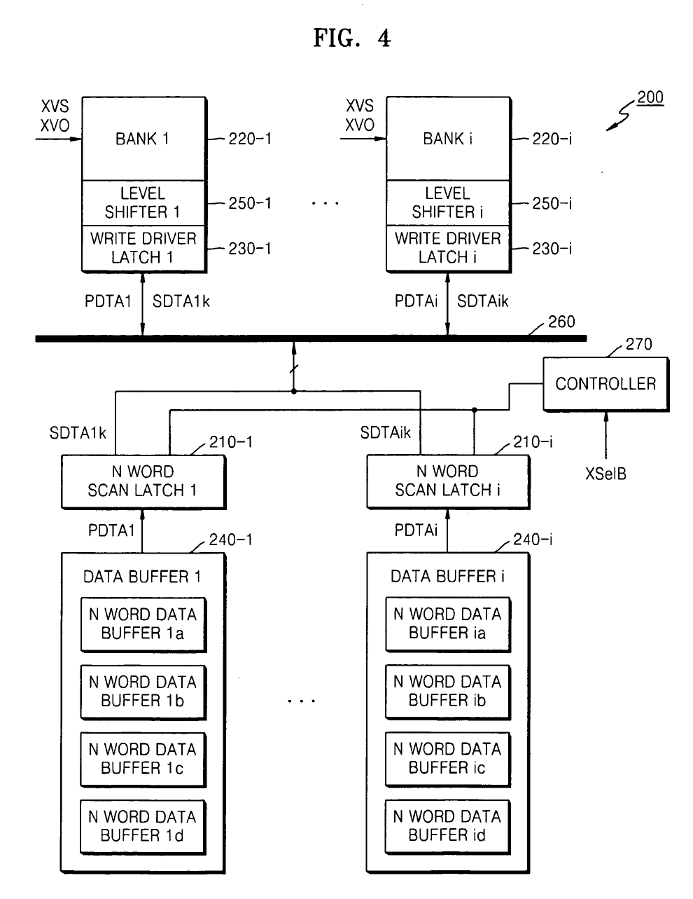

The data buffers 140-1 through 140-i of the semiconductor memory device 100 according to example embodiments may store the program data to be programmed in the corresponding banks. Hereinafter, the semiconductor memory device will now be described with reference to FIG. 4.

FIG. 4 is a block diagram of a semiconductor memory device 200 according to example embodiments. Referring to FIG. 4, data buffers 240-1 through 240-i of the semiconductor memory device 200 may store program data to be programmed in the corresponding banks. For example, the 1^{st} data buffer 240-1 may store program data PDTA1 to be programmed in the 1^{st} bank 220-1, and the i^{st} data buffer 240-i may store program data PDTAi to be programmed in the i^{st} bank 220-i.

In example embodiments, a data buffer may correspond to a bank. However, according to example embodiments, two or more banks may correspond to one data buffer.

Each data buffer 240-1 through 240-i may comprise sub data buffers 1a˜1d through ia˜id. Each sub data buffer 1a˜1d through ia˜id may have the size of an N words when each program data PDTA1 through PDTAi comprises N words, where N is a natural number. Therefore, the data buffers 240-1 through 240-i can store the program data by the number of the sub data buffers.

Referring to FIG. 4, the semiconductor memory device 200 may further comprise scan latches 210-1 through 210-i. The scan latches 210-1 through 210-i may scan program data transmitted from the corresponding data buffers 240-1 through 240-i. For example, the 1^{st} scan latch 210-1 may scan the program data PDTA1 of the 1^{st} data buffer 240-1 and scan the program data PDTAi of the i^{st} data buffer 240-i.

In example embodiments, data buffers 240-1 through 240-i may correspond to scan latches 210-1 through 210-i.

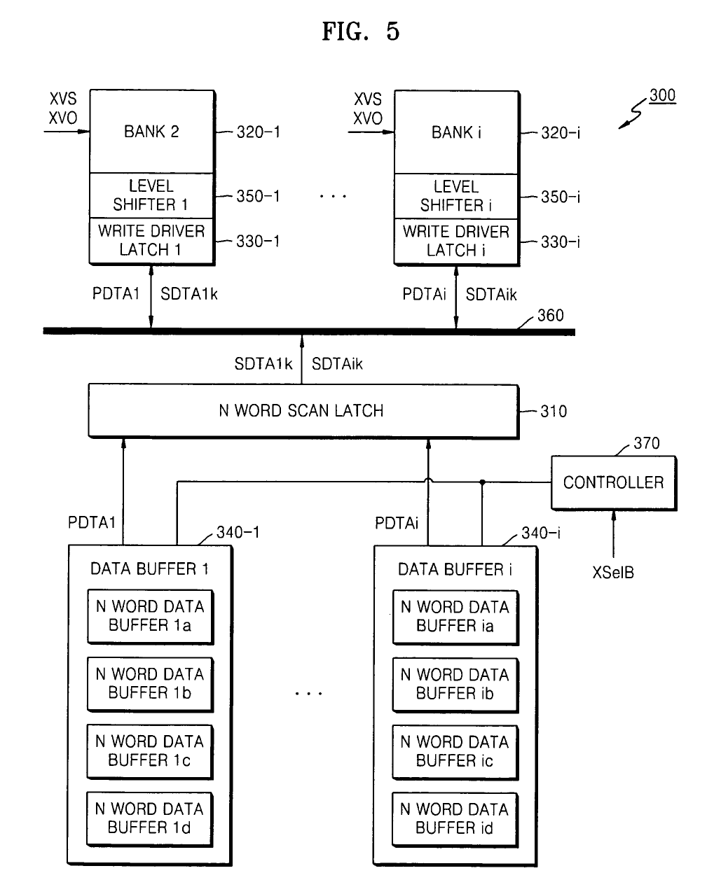

Referring to FIG. 5, which is a block diagram of a semiconductor memory device 300 according to example embodiments, some of a plurality of data buffers 340-1 through 340- may share an N word scan latch 310.

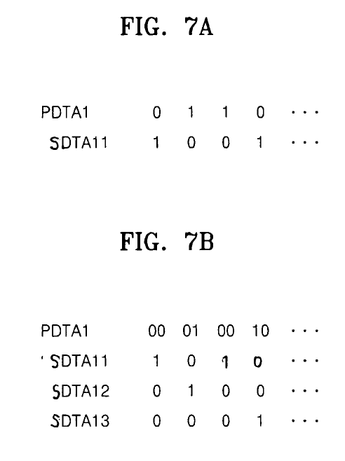

FIGS. 7A and 7B are diagrams for explaining sub program data. Referring to FIGS. 4 and 7A, if the semiconductor memory device 200 is a single level cell (SLC) flash memory device, the 1^{st} scan latch 210-1 may generate the program data PDAT1 as 1^{st} sub program data SDTA11. For example, bits having a value 0 may be scanned among the program data PDTA1 “0110 . . . ” to generate the 1^{st} sub program data SDTA11 “1001 . . . ”. In general, since a NOR flash memory device writes 1 or 11 in all memory cells during a verifying operation, it does not need an additional operation for writing 1 or 11 in all memory cells.

If the semiconductor memory device 200 is a multi level cell (MLC) flash memory device, the 1^{st} scan latch 210-1 may generate the program data PDAT1 as the 1^{st} sub program data SDTA11, 2^{nd} sub program data SDTA12, and 3^{rd} sub program data SDTA13. For example, bits having a value 00 may be scanned among the program data PDTA1 “00 01 00 10 . . . ” to generate the 1^{st} sub program data SDTA11 “1 0 1 0 . . . ”. Next, bits having a value 01 may be scanned to generate the 2^{nd} sub program data SDTA12 “0 1 0 0 . . . ”. Finally, bits having a value 10 may be scanned to generate the 3^{rd} sub program data SDTA13 “0 0 0 1 . . . ”.

In example embodiments, although the operation of the 1^{st} scan latch 210-1 is described, the operation of the i^{th} scan latch 210-i can be easily derived.

The semiconductor memory device 200 may further comprise write driver latches 230-1 through 230-i. The generated sub program data may be sequentially transmitted to the corresponding write driver latches from among latches 230-1 through 230-i. The operation of each of the plurality of write driver latches 230-1 through 230-i will now will be described in terms of write driver latch 230-1. The write driver latch 230-1 may store the 1^{st} sub program data SDTA11 while programming the corresponding 1^{st} sub program data SDTA11, in order to maintain a data value until completing a program operation with regard to the 1^{st} sub program data SDTA11. Likewise, the write driver latches 230-1 may store the 2^{nd} sub program data SDTA12 while programming the corresponding 2^{nd} sub program data SDTA12. Each scan latch, 210-1 through 210-i, may generate the 2^{nd} sub program data while 1^{st} sub program data stored in the write driver latches 230-1 through 230-i is being programmed. For example, scan latch 210-1 may generate 2^{nd} sub program data SDTA12 while 1^{st} sub program data SDTA11 stored in driver latch 230-1 is being programmed.

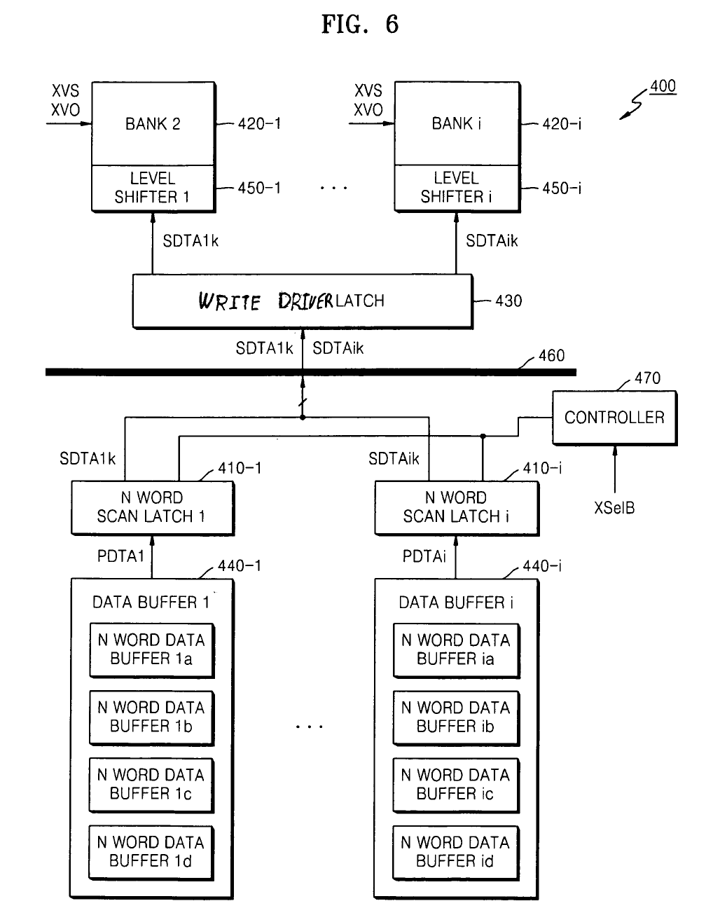

Referring to FIG. 4, each bank 220-1 through 220-i may correspond, respectively, to write driver latches 230-1˜230-i that may be disposed between the banks 220-1 through 220-i and the data transmission line 260. Referring to FIG. 6, which is a block diagram of a semiconductor memory device 400, some banks, from among banks 420-1 through 420-i, may share the write driver latch 430. Write driver latch 430 may be disposed between a data transmission line 460 and data buffers 440-1 and 440-i.

Referring to FIG. 4, the semiconductor memory device 200 may further comprise a controller 270. The controller 270 may temporally divide access to use transmission line 260 between the banks 220-1 through 220-i and the data buffers 240-1 through 240-i, and may cause the program data, or the sub program data, to be transmitted between the corresponding banks and data buffers.

For example, the controller 270 may control a data transmission between the plurality of banks 220-1 through 220-i and the data buffers 240-1 through 240-i connected to the data transmission line 260 in response to a bank selection signal XSelB. For example, when the bank selection signal XSelB selects the 1^{st} bank 220-1, the 1^{st} data buffer 240-1 may transmit the program data PDTA1 to the 1^{st} bank 220-1 through the data transmission line 260. When the bank selection signal XSelB selects the i^{th} bank 220-i, the i^{th} data buffer 240-i may transmit the program data PDATi to the i^{th} bank 220-i through the data transmission line 260.

If the sub program data SDTA1k through SDTAik is transmitted to the write driver latches 230-1 through 230-i, the semiconductor memory device 200 may apply bias voltages corresponding to the sub program data SDTA1k through SDTAik to bit lines connected to memory cells (not shown) that are to be programmed using level shifters 250-1 through 250-i. Banks 220-1 through 220-i may correspond, respectively, to level shifters 250-1 through 250-i.

If the semiconductor memory device 200 applies the bias voltage to bit lines of all the banks to be programmed, device 200 may simultaneously perform a program operation with regard to the banks 220-1 through 220-i in response to a 1^{st} control signal XVS. If the 1^{st} control signal XVS is applied, the semiconductor memory device 200 may apply a program voltage to word lines of the all selected banks, thereby simultaneously programming the banks.

The semiconductor memory device 200 may simultaneously perform an authentication operation with regard to the banks 220-1˜220-i in response to a 2^{nd} control signal XVO. As described above, an authentication operation of comparing program data programmed in a selected memory cell and program data stored in a buffer after an internally predetermined period of time of programming program data in a memory cell is performed. If the 2^{nd} control signal XVO is applied, the semiconductor memory device 200 may simultaneously output program data selected from all the banks, and compare the program data programmed in the banks with the program data stored in the data buffer.

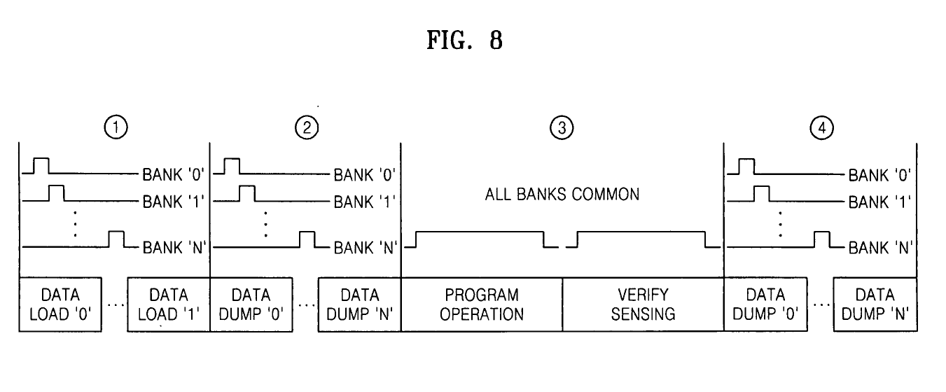

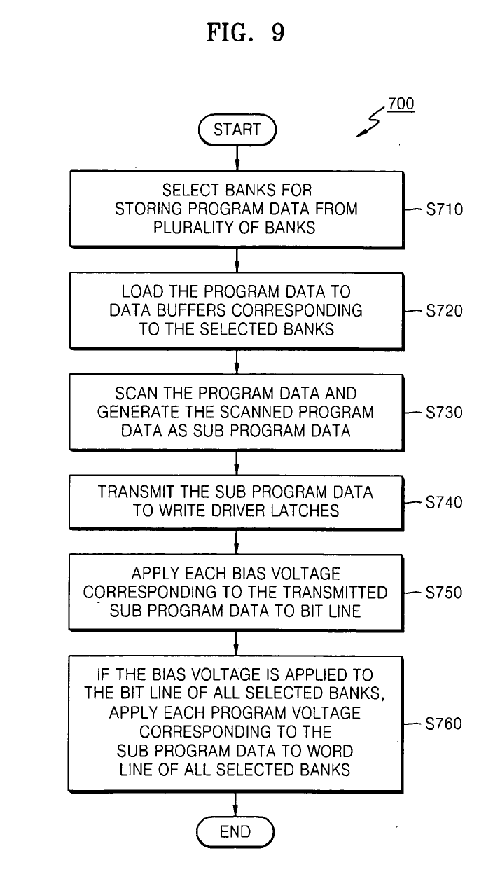

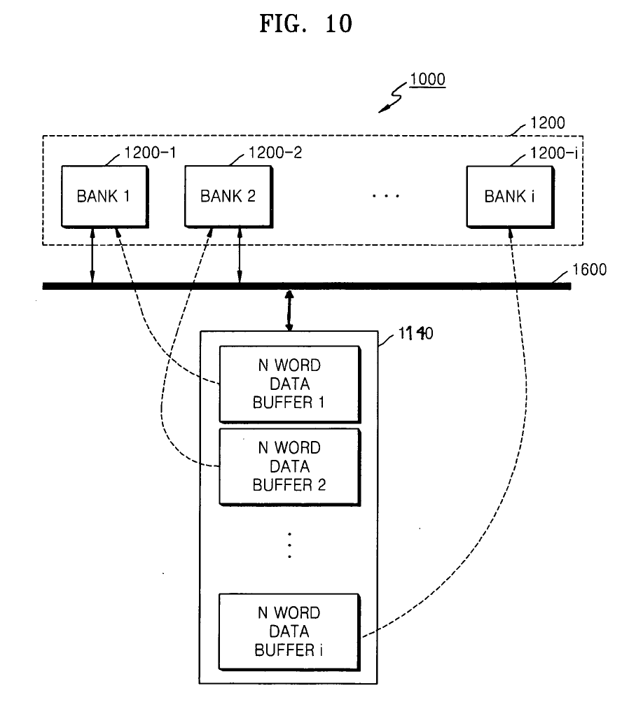

FIG. 8 is a diagram for explaining an operation of the semiconductor memory device shown in FIGS. 4 through 6. FIG. 9 is a flowchart illustrating a program method according to example embodiments.

Referring to FIGS. 8 and 9, the method 700 of programming a plurality of banks may include operations S710˜S760. Operation S710 may include selecting banks for storing program data from the plurality of banks based on an address of the program data. In operation S720, the corresponding program data may be sequentially loaded to data buffers corresponding to the selected banks (step \textcircled{1} shown in FIG. 8,).

In operation S730, the program data loaded to each data buffer may be scanned as 1^{st} through n−1^{th} sub program data, where n may be a natural number greater than 2. If, in operation S740, the 1^{st} through n−1^{th} sub program data is sequentially transmitted to each bank (step \textcircled{2} shown in FIG. 8), each bias voltage corresponding to the transmitted sub program data may be applied to a bit line connected to a memory cell among bit lines of the selected banks for programming the program data.

In operation S760, if the bias voltages are applied to the bit lines of all the selected banks, each program voltage corresponding to the sub program data may be applied to a word line connected to the memory cell for programming the program data among word lines of the selected banks, and may be simultaneously applied to all the selected banks, so that the all selected banks are simultaneously programmed (step \textcircled{3} shown in FIG. 8 ).

The operation \textcircled{3} shown in FIG. 8 may be divided into a program operation and an authentication sensing operation. According to example embodiments, the program method 700 may further perform an authentication operation with regard to program data programmed in all selected banks, and simultaneously perform the authentication operation with regard to all selected banks. In order to perform the authentication operation, sensed program data may be sequentially dumped to the corresponding data buffers (step \textcircled{4} shown in FIG. 8).

FIG. 10 is a diagram of a semiconductor memory device 1000 according to example embodiments. Referring to FIG. 10, the semiconductor memory device 1000 may comprise a data buffer 1140. The data buffer 1140 may store a plurality of pieces of program data PDTA, in a manner similar to the data buffers shown in FIG. 3. The data buffer 1140 may comprise a plurality of sub data buffers which may each store program data to be programmed in the corresponding banks among the plurality of pieces of program data PDTA.

For example, when the size of the data buffer 1140 necessary for a single bank program is N words and M banks are simultaneously programmed, the semiconductor memory device 1000 may divide the data buffer 1140 into M sub data buffers (N word data buffer 1 through N word data buffer i), and allocate each sub data buffer to the corresponding bank.

For example, the 1^{st} sub data buffer (N word data buffer 1) may be allocated to the 1^{st} bank and the 2^{nd} sub data buffer (N word data buffer 2) may be allocated to the 2^{nd} bank. In the same manner, the M^{th} sub data buffer (N word data buffer i) may be allocated to the i^{th} bank to store program data to be programmed in the M^{th} bank.

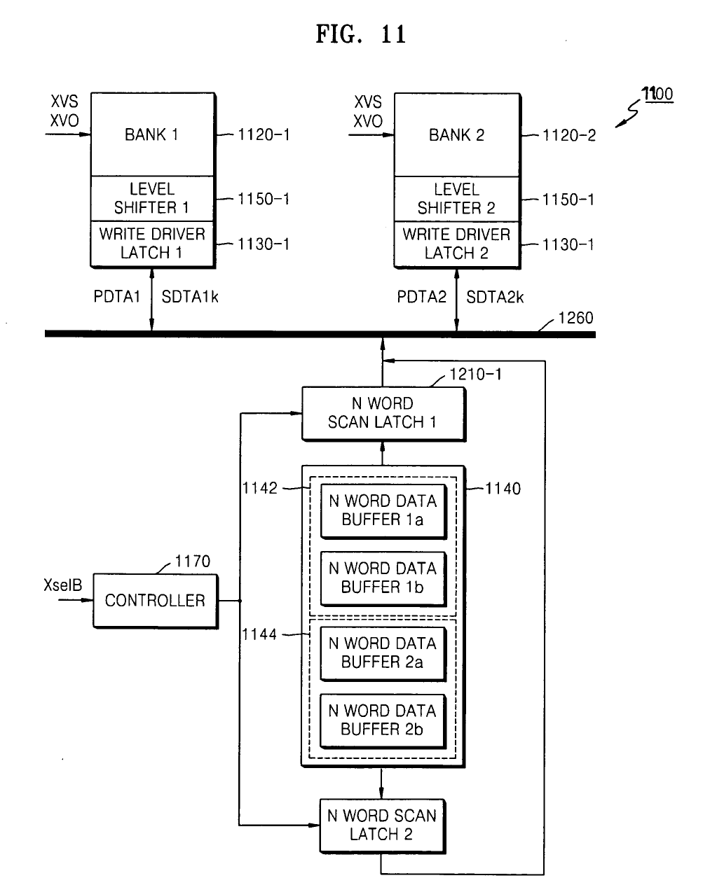

FIG. 11 is a block diagram of a semiconductor memory device 1100 according to example embodiments. Referring to FIG. 11, the semiconductor memory device 1100 may comprise two banks bank 1 and bank 2 that may share a data buffer 1140 which may include two sub data buffers 1142 and 1144. The 1^{st} sub data buffer 1142 may be allocated to the bank 1. The 2^{nd} sub data buffer 1144 may be allocated to the bank 2.

Each sub data buffer may comprise N word data buffers for storing a plurality of words. In at least one example embodiment, each of the 1^{st} and 2^{nd} sub data buffers 1142 and 1144 may comprise two N word data buffers, N word data buffers 1a and 1b and N word data buffers 2a and 2b.

An operation of simultaneously programming the banks 1 and 2 using the two sub data buffers 1142 and 1144 may be replaced with the description of the semiconductor memory device shown in FIG. 4.

The semiconductor memory devices 1000 and 1100 can simultaneously program a plurality of banks without additional data buffers, thereby reducing an increase in the layout size of the semiconductor memory device and enhancing program performance.

A semiconductor memory device according to example embodiments may comprise data buffers corresponding to each or some of a plurality of banks and may simultaneously program the plurality of banks, which may enhance a program speed of a NOR flash memory device.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A semiconductor memory device comprising:
a memory cell array including a plurality of banks;
a plurality of data buffers storing a plurality of program data to be programmed in the corresponding banks; and
a plurality of scan latches configured to scan the plurality of program data transmitted from the corresponding data buffers, and configured to generate 1^{st} through n−1^{th} sub program data, n being a natural number greater than 2.

2. The semiconductor memory device of claim 1, wherein each of the plurality of data buffers corresponds to a bank from among the plurality of banks.

3. The semiconductor memory device of claim 1, wherein each of the plurality of data buffers corresponds to at least two banks from among the plurality of banks.

4. The semiconductor memory device of claim 1, further comprising: a data transmission line shared by the plurality of banks and the plurality of data buffers, the data transmission line being configured to transmit the plurality of program data.

5. The semiconductor memory device of claim 4, further comprising: a controller configured to control access to the data transmission line on a time-sharing basis for the plurality of banks and the plurality of data buffers, and configured to control a transmission of the plurality of program data between the corresponding banks and data buffers.

6. The semiconductor memory device of claim 1, wherein the semiconductor memory device is configured to simultaneously perform a program operation with regard to the plurality of banks in response to a first control signal.

7. The semiconductor memory device of claim 1, wherein the semiconductor memory device is configured to simultaneously perform a verifying operation with regard to the plurality of banks in response to a second control signal.

8. The semiconductor memory device of claim 1, wherein n is 2 when the semiconductor memory device is a single level cell (SLC) flash memory device, and n is 4 when the semiconductor memory device is a multi level cell (MLC) flash memory device.

9. The semiconductor memory device of claim 1, wherein each of the plurality of scan latches corresponds to one data buffer from among the plurality of data buffers.

10. The semiconductor memory device of claim 1, wherein at least one of the plurality of scan latches is shared by two or more of the plurality of data buffers.

11. The semiconductor memory device of claim 1, further comprising: a plurality of write driver latches configured to store k^{th} sub program data while the k^{th} sub program data is programmed, k being a natural number satisfying 1≦k≦n−1.

12. The semiconductor memory device of claim 11, wherein each of the plurality of write driver latches corresponds to a bank from among the plurality of banks.

13. The semiconductor memory device of claim 11, wherein at least one of the plurality of write driver latches corresponds to one or more banks from among the plurality of banks.

14. The semiconductor memory device of claim 11, wherein the plurality of write driver latches is disposed between the plurality of banks and a data transmission line.

15. The semiconductor memory device of claim 11, wherein the plurality of write driver latches is disposed between a data transmission line and the plurality of data buffers.

16. The semiconductor memory device of claim 11, wherein the semiconductor memory device is configured so that if k is not equal to n−1, the plurality of scan latches generate the k+1^{th} sub program data while the k^{th} sub program data is programmed.

17. The semiconductor memory device of claim 1, further comprising: a plurality of level shifters configured to apply bias voltages corresponding to the sub program data to bit lines connected to memory cells for programming the plurality of program data.

18. The semiconductor memory device of claim 17, wherein each of the level shifters corresponds to a bank from among the plurality of banks.

19. The semiconductor memory device of claim 1, wherein the semiconductor memory device is a NOR flash memory device.
